(19) United States
(12) Patent Application Publication
(10) Pub. No.: US 2011/0281017 A1
(43) Pub. Date: Nov. 17, 2011

(54) METHODS FOR DETOXIFYING OIL SEED CROPS

(75) Inventor: John Douglas Brooker, London (GB)

(73) Assignee: D1 OILS PLC, Leeds (GB)

(21) Appl. No.: 13/133,269

(22) PCT Filed: Nov. 30, 2009
(86) PCT No.: PCT/GB2009/002789

§ 371 Date: Aug. 2, 2011

(30) Foreign Application Priority Data
Dec. 15, 2008 (GB) 0822805.8

(51) Int. Cl. A23L 1/36; C11B 1/10; A23K 1/24; A23L 1/015; A23K 1/14; A23K 1/18

(52) U.S. Cl. 426/630; 426/629; 426/417

(57) ABSTRACT

Described are methods for extracting oil and phorbol esters from oil seed kernel, for example from Jatropha curcas oil seed kernel. The methods comprise treating the oil seed kernel with at least one solvent and separating the resultant solvent/oil mix from the treated kernel to leave a seedcake substantially free of phorbol esters. Also described are seedcakes produced by the methods which can be used as nutritional compositions, for example as animal feeds.

The present application relates to methods for detoxifying oil seed crops, in particular to methods for removing toxins and anti-nutritional factors from Jatropha curcas seed kernels.

Jatropha curcas is a tropical plant whose seed oil has potential in the biodiesel industry, and potentially contains components of value chemically and pharmaceutically.

Conventionally, oil is separated from oil seed crops by pressing prepared oil seeds in a screw press. This is known as expelling and uses pressure to squeeze the oil from the cells of the seed. Various techniques are used to enhance the oil yield such as preheating (cooking) and adjusting pressure and screw design which result in a seedcake containing about 5% by weight residual oil. To obtain higher oil removal yields other techniques such as solvent extraction are used. In this case seeds are prepared through crushing or flaking and solvents such as hexane are passed over seed material to enable the oil to be removed from the cells of the seed by desorption.

In oil seeds with high oil content, conventional solvent extraction methods include a preparation step of prepressing the seeds to reduce the oil content down to below 15% by weight. This is required to optimise the downstream processing and reduce the amount of solvent that must be recovered from the extracted oil.

It is common that a certain degree of fibre remains in the resultant seedcake to allow the solvent extraction process to function without loss of porosity in the cake and loss of extraction efficiency. In this case it is common to include a certain proportion of seed shell or other fibre sources within the feed to the expellor. In order to produce a seedcake with low levels of fibre, a higher degree of de-hulling can be employed.

Typical solvent extraction processes involve four basic steps. These are preparation, extraction, solvent recovery from the extracted oil (termed miscella), and desolventizing/toasting or flash desolventizing of the de-oiled seedcake. Conventional preparation generally comprises the steps of (1) rough cleaning (often termed scalping) to remove foreign material; (2) drying to loosen hulls; (3) additional cleaning; (4) cracking to break the oilseed into pieces properly sized for dehulling and flaking; (5) optional dehulling (if seeking to produce high-protein seedcake for animal consumption or flour for human consumption); (6) conditioning to adjust temperature and water content; (7) flaking; and (8) optionally converting flakes into collets via use of “expanders” in a colleting step. In the optional colleting step, expanders (also termed extruders) are used to transform flakes into sponge-like extrudates termed collets. Collets are larger, denser, less fragile, and more porous than flakes. Thus, collets are not as likely as flakes to hinder solvent percolation, and hence extract more rapidly and drain more completely after extraction, thereby reducing the amount of solvent that must be recovered in desolventizing of the extracted solids.

In conventional solvent extraction, solvent partitions oil and other solvent-miscible components into a liquid miscella phase, leaving a de-oiled seedcake (also termed extracted drained flakes, extracted solids or defatted solvent laden flakes). Physical contact between the solvent and prepared oilseeds typically occurs either by immersing prepared oilseeds in solvent, percolating solvent through a bed of prepared oilseeds, or some combination of both. Solvent in the miscella phase is recovered by vaporization, generally conducted under steam stripping conditions. Residual solvent in the de-oiled seed meal, sometimes referred to as hold-up solvent, is generally recovered either in a desolventizing/toasting system or in a flash desolventizing system, depending on the intended use of the seedcake. Desolventizing/toasting systems are used to produce a toasted product that is nutritionally well suited for use in animal feeds. The term “toasted” as used by oilseed processors generally means cooked with steam, rather than dry heat.

Flash desolventizing systems on the other hand are used to produce human foods such as flours, protein concentrates, or protein isolates. Extracted flakes used as precursors in such food production must be desolventized with minimal heat exposure in order to preserve high protein content.

In the case of oil extraction from Jatropha curcas, it has been difficult to find uses for the by-products.

The potential of Jatropha curcas to be used for animal feed has been investigated and it has been shown that protein levels in the defatted kernels can be as high as around 64% by weight. It has also been shown that raw Jatropha contains phorbol esters, cursin, phytate, trypsin inhibitors and saponins, at levels that are unsuitable for animal feed.

Some groups have attempted to reduce the level of toxins and anti-nutritional factors to levels suitable for animal feed, however, this has been largely unsuccessful.

Others have attempted, unsuccessfully, to use a combination of techniques including pressing, solvent extraction and heat treatment but none have demonstrated detoxification of Jatropha kernels to acceptable levels.

In addition, whilst some groups claimed to have produced industrially “detoxified” Jatropha curcas meal (seedcake), this “detoxified” meal has subsequently been shown to be toxic.

For example, as discussed in Chivandi et al (2006) Research Journal of Animal and Veterinary Sciences 1(1), 18-24, pigs which were fed a diet based on industrially “detoxified” Jatropha curcas meal developed diarrhoea that was persistent. In this paper, it was summarised that the detoxification procedure used to produce the Jatropha curcas meal failed to completely remove and or neutralise the toxins and anti-nutritional factors and that some of the toxicity observed can be ascribed to the residual phorbol esters in the Jatropha curcas meal.

In addition, many of the techniques which have been tried result in impaired oil extraction from the Jatropha seed kernel and require extensive, labour intensive protocols for removal of phorbol esters and inactivation of anti-nutritional factors from the defatted seedcake.

It is, therefore, an object of the present invention to seek to alleviate the above identified problems.

### SUMMARY OF THE INVENTION

In one aspect of the present invention, there is provided a method for extracting oil and phorbol esters from oil seed kernel, the method comprising: —

(a) treating the oil seed kernel with at least one solvent; and

(b) separating the resultant solvent/oil mix from the treated kernel to leave a seedcake (seedmeal) substantially free of phorbol esters.

In this respect, it has surprisingly been found that phorbol esters can be removed from oil seed kernel at the same time as extracting oil without having to resort to the known methods which attempt to remove phorbol esters from the seedcake after the oil has been extracted/expelled.

The term “phorbol ester” is known in the art and is based on the following structure which is free phorbol.

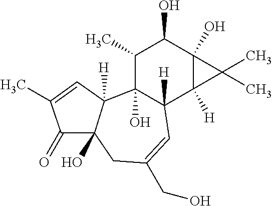

The basic phorbol structure found in Jatropha curcas is the diterpene, 12 deoxy-16 hydroxy phorbol (DHP), and all known Jatropha curcas phorbol esters are diester structures with substituents on the C13 and C16 groups. The full structures are reported in Haas and Mittelbach (2002) (Haas, W. Sterk, H. Mittelbach, M. Novel 12-deoxy-16-hydroxyphorbol diesters isolated from the seed oil of Jatropha curcas. (2002). Journal of Natural Products. 65: 10, 1434-1440, the content of which is incorporated herein by reference in its entirety), but comprise DHP with 7 variants of C24 unsaturated side chains on C13 and C16. In contrast, the phorbol ester standard used in all analytical work is phorbol 12-tetradodecanyl (myristate), 13-acetate (TPA or PMA).

The methods of the present invention, therefore, have a number of advantages over known methods, for example in terms of efficiency and cost.

The methods of the present invention may be performed as batch or continuous extraction methods.

Preferably, the seedcake comprises defatted solvent laden flakes (DSF).

Preferably, the oil seed kernel is from Jatropha curcas.

Preferably, the solvent comprises a mixture of two or more solvents. Preferably, the solvent comprises at least one hydrophobic solvent. Preferably, the solvent comprises at least one hydrophilic solvent.

Preferably, the solvent comprises a mixture of two or more solvents, wherein one of the solvents is more hydrophilic than another solvent in the mixture. In this embodiment, the solvent can be said to comprise at least one hydrophobic solvent and at least one hydrophilic solvent. The solvents in the mixture are termed hydrophobic or hydrophilic depending upon their relative hydrophilic characters.

Preferably, the solvent comprises between about 30% by weight and about 70% by weight hydrophobic solvent, preferably between about 30% by weight and about 60% by weight, preferably between about 30% by weight and about 50% by weight, preferably between about 35% by weight and about 45% by weight. Preferably, the solvent comprises about 40% by weight hydrophobic solvent.

In other embodiments, the solvent comprises between about 30% by weight and about 70% by weight hydrophobic solvent, preferably between about 40% by weight and about 70% by weight, preferably between about 50% by weight and about 60% by weight, preferably between about 52% by weight and about 58% by weight. Preferably, the solvent comprises about 55% by weight hydrophobic solvent.

Preferably, the solvent comprises an azeotropic mix of a hydrophobic and a hydrophilic solvent.

Preferably, the solvent comprises an alkane, an ester, an alcohol, a heterocyclic organic compound, water or a combination of two or more thereof.

Preferably, the solvent comprises less than about 6 carbon atoms, preferably between about 2 and about 4 carbon atoms.

Preferably, the alcohol is an alkanol. Preferably, the ester is selected from an ester of methane, ethane, propane, or butane. Preferably, the heterocyclic organic compound is tetrahydrofuran.

Preferably, the solvent comprises hexane, methyl acetate, ethyl acetate, methanol, ethanol, water, tetrahydrofuran or a combination of two or more thereof.

Preferably, the solvent comprises a mixture of ethyl acetate and methanol. Preferably, the solvent comprises between about 30% by weight and about 70% by weight ethyl acetate, preferably between about 30% by weight and about 60% by weight, preferably between about 30% by weight and about 50% by weight, preferably between about 35% by weight and about 45% by weight. Preferably, the solvent comprises about 40% by weight ethyl acetate.

In another embodiment, wherein the solvent comprises a mixture of ethyl acetate and methanol, the solvent preferably comprises between about 30% by weight and about 70% by weight ethyl acetate, preferably between about 40% by weight and about 70% by weight, preferably between about 50% by weight and about 60% by weight, preferably between about 52% by weight and about 58% by weight, preferably about 55% by weight ethyl acetate.

Preferably, the solvent comprises an azeotropic mixture of ethyl acetate and methanol. As such, it is preferred that the solvent comprises about 56% by weight ethyl acetate.

It will be appreciated that in the embodiments described above, ethyl acetate may be replaced by methyl acetate and/or methanol may be replaced by ethanol (or other solvents as described as preferred solvents herein). As such, preferred embodiments relate to a method wherein the solvent comprises a mixture, preferably an azeotropic mixture, of methyl acetate and methanol, or of methyl acetate and ethanol, or of ethyl acetate and ethanol, or of ethyl acetate and methanol.

Preferably, step (a) comprises treating the oil seed kernel with a first solvent followed by a second solvent.

Preferably, the first solvent and/or the second solvent comprises a mixture of two or more solvents. Preferably, the first solvent and/or the second solvent comprises at least one hydrophobic solvent. Preferably, the first solvent and/or the second solvent comprises at least one hydrophilic solvent.

Preferably, the first solvent and/or the second solvent comprises a mixture of two or more solvents, wherein one of the solvents is more hydrophilic than another solvent in the mixture. In this embodiment, the first solvent and/or the second solvent can be said to comprise at least one hydrophobic solvent and at least one hydrophilic solvent. The solvents in the mixture are termed hydrophobic or hydrophilic depending upon their relative hydrophilic character.

Preferably, the first solvent and/or the second solvent comprises between about 30% by weight and about 70% by weight hydrophobic solvent, preferably between about 30% by weight and about 60% by weight, preferably between about 30% by weight and about 50% by weight, preferably between about 35% by weight and about 45% by weight. Preferably, the first solvent and/or the second solvent comprises about 40% by weight hydrophobic solvent.

In other embodiments, the solvent comprises between about 30% by weight and about 70% by weight hydrophobic solvent, preferably between about 40% by weight and about 70% by weight, preferably between about 50% by weight and about 60% by weight, preferably between about 52% by weight and about 58% by weight. Preferably, the solvent comprises about 55% by weight hydrophobic solvent.

Preferably, the first solvent and/or the second solvent comprises an azeotropic mix of a hydrophobic and a hydrophilic solvent.

Preferably, the first solvent and/or the second solvent comprises an alkane, an ester, an alcohol, a heterocyclic organic compound, water or a combination of two or more thereof.

Preferably, the first solvent and/or the second solvent comprises less than about 6 carbon atoms, preferably between about 2 and about 4 carbon atoms.

Preferably, the alcohol is an alkanol. Preferably, the ester is selected from an ester of methane, ethane, propane, or butane. Preferably, the heterocyclic organic compound is tetrahydrofuran.

Preferably, the first solvent and/or the second solvent comprises hexane, methyl acetate, ethyl acetate, methanol, ethanol, water, tetrahydrofuran or a combination of two or more thereof.

Preferably, the first solvent and/or the second solvent comprises a mixture of ethyl acetate and methanol. Preferably, the first solvent and/or the second solvent comprises between about 30% by weight and about 70% by weight ethyl acetate, preferably between about 30% by weight and about 60% by weight, preferably between about 30% by weight and about 50% by weight, preferably between about 35% by weight and about 45% by weight. Preferably, the first solvent and/or the second solvent comprises about 40% by weight ethyl acetate.

In another embodiment, wherein the first solvent and/or the second solvent comprises a mixture of ethyl acetate and methanol, the solvent preferably comprises between about 30% by weight and about 70% by weight ethyl acetate, preferably between about 40% by weight and about 70% by weight, preferably between about 50% by weight and about 60% by weight, preferably between about 52% by weight and about 58% by weight, preferably about 55% by weight ethyl acetate.

Preferably, the first solvent and/or the second solvent comprises an azeotropic mixture of ethyl acetate and methanol. As such, it is preferred that the first solvent and/or the second solvent comprises about 56% by weight ethyl acetate.

It will be appreciated that in the embodiments described above, ethyl acetate may be replaced by methyl acetate and/or methanol may be replaced by ethanol (or other solvents as described as preferred solvents herein). As such, preferred embodiments relate to a method wherein the first solvent and/or the second solvent comprises a mixture, preferably an azeotropic mixture, of methyl acetate and methanol, or of methyl acetate and ethanol, or of ethyl acetate and ethanol, or of ethyl acetate and methanol.

Accordingly, in a preferred embodiment, step (a) comprises treating the oil seed kernel with a first solvent following by a second solvent, wherein the first solvent is a mixture of ethyl acetate and methanol and the second solvent is methanol.

Preferably, the oil seed kernel is treated with the solvent at a temperature greater than about 20° C., preferably greater than about 40° C., preferably greater than about 55° C. Preferably, the oil seed kernel is treated with the solvent at a temperature of about 63° C.

It will be appreciated that the preferred temperatures identified above are based upon the methods of the invention being performed at a pressure of 1 atmosphere absolute. The preferred temperatures will vary in response to changes made to the pressure at which the methods are carried out. For example, in one embodiment, the oil seed kernel is treated with the solvent at a temperature of 62° C. and 1.2 bar absolute.

Preferably, prior to treatment with solvent, the kernel is reduced in size. For example, the kernel may be reduced in size by milling or flaking.

Preferably, the kernel is reduced to a particle size of less than about 2 mm in one dimension. Preferably, the particle size is less than about 1.5 mm in one dimension, preferably less that about 1 mm, preferably less than about 0.5 mm, preferably between about 0.2 mm and about 0.5 mm.

Preferably, following step (b), the seedcake comprises less than about 5% by weight oil. Preferably, the seedcake comprises less than about 4% by weight oil, preferably less than about 3% by weight, preferably less than about 2% by weight, preferably less than about 1% by weight. Preferably, the seedcake comprises less than about 0.5% by weight oil. Preferably, the seedcake comprises substantially no oil.

In this respect, following the methods of the present invention, the resultant seedcake preferably comprises less than about 5% by weight oil. Preferably, the seedcake comprises less than about 4% by weight oil, preferably less than about 3% by weight, preferably less than about 2% by weight, preferably less than about 1% by weight. Preferably, the seedcake comprises less than about 0.5% by weight oil. Preferably, the seedcake comprises substantially no oil.

Preferably, oil is not pre-expelled from the seed kernel prior to treatment with the solvent. In this respect, it has surprisingly been found that if the seed kernel is subjected to an initial pressing treatment to remove an initial fraction of oil, the amount of phorbol esters removed from the seed kernel following the methods of the invention described above is reduced. As such, it is preferred that the methods of the present invention do not include a step of pressing the oil seed kernel.

Preferably, the seed kernel is not subjected to heat treatment prior to treatment with the solvent. In this respect, it has surprisingly been found that if the seed kernel is subjected to an initial heat treatment, the amount of phorbol esters removed from the seed kernel following the methods of the invention described above is reduced. As such, it is preferred that the methods of the present invention do not include a pre-step of heating the oil seed kernel.

Preferably, step (a) comprises mixing the solvent with the oil seed kernel in an agitated batch vessel or continuous extractor. Preferably, the solvent is mixed with the oil seed kernel in a number of stages. Preferably, at each stage solvent containing less oil is mixed with the oil seed kernel. Preferably, at each stage fresh solvent is mixed with the oil seed kernel.

Preferably, prior to the methods described above, the oil seed kernel is prepared by dehulling the oil seed. Preferably, the oil seed kernel used in the methods described above comprises at least about 80% by weight oil seed kernel. Preferably, the oil seed kernel comprises at least about 90% by weight oil seed kernel, preferably at least about 95% by weight, preferably at least about 97% by weight, preferably at least about 98% by weight. Preferably, the oil seed kernel comprises at least about 99% by weight oil seed kernel, preferably at least about 99.9% by weight oil seed kernel, preferably 100% by weight oil seed kernel.

In this respect, it will be appreciated that if the oil seed kernel used in the methods described above does not comprise 100% by weight oil seed kernel, then the rest of the weight relates to non oil seed kernel material, for example shell material left over from dehulling the oil seed. In preferred embodiments, the oil seed kernel used in the methods and the resultant seedcake comprises no shell material.

Preferably, the seedcake does not contain shell material. Preferably, the seedcake comprises less than about 1% by weight shell material, preferably less than about 5% by weight, less than about 10% by weight, preferably less than about 20% by weight shell material.

Preferably, the methods of the invention result in extraction of at least about 80% by weight of the oil in the oil seed kernel, preferably at least about 90% by weight, preferably at least about 95% by weight, preferably at least about 97% by weight, preferably at least about 98% by weight, preferably at least about 99% by weight.

Preferably, at least about 40% oil by weight of kernel is extracted, preferably at least about 45% by weight, preferably at least about 50% by weight.

Preferably, the seedcake comprises at least about 50% by weight protein, preferably at least about 60% by weight protein, preferably at least about 64% by weight protein.

Preferably, the protein comprises at least about 60% by weight digestible protein, preferably at least about 65% by weight, preferably at least about 70% by weight, preferably at least about 80% by weight, preferably at least about 85% by weight, preferably at least about 90% by weight, preferably at least about 95% by weight, preferably at least about 97% by weight, preferably at least about 98% by weight digestible protein.

The solvent/oil mix can be separated from the seedcake using methods known in the art.

Preferably, the method comprises a further step (c), comprising treating the seedcake to remove or denature antinutritional factors.

Preferably, step (c) comprises treating the seedcake to remove or denature antinutritional factors selected from one or more of cursin, trypsin inhibitors, lectins, phytates, saponins or other factors.

Preferably, step (c) comprises treating the seedcake with moist heat. Preferably, the seedcake is treated with moist heat at a temperature of between about 100° C. and about 160° C., preferably between about 110° C. and about 140° C., preferably between about 115° C. and about 130° C., preferably about 120° C.

According to another aspect of the present invention, there is provided a seedcake produced by the methods described above.

Preferably, the seedcake comprises less than about 100 ppm phorbol esters, preferably less than about 50 ppm phorbol esters, preferably less than about 30 ppm phorbol esters, preferably less than about 20 ppm phorbol esters, preferably less than about 10 ppm phorbol esters. Preferably, the seedcake comprises undetectable levels of phorbol esters.

The seedcake produced by the methods according to the present invention can be used as a nutritional composition. As such, the methods according to the present invention are also suitable for producing a nutritional composition.

In one example of the present invention, there is provided a method for producing a nutritional composition from oil seed kernel, the method comprising:

(a) treating the oil seed kernel with a solvent; and

(b) separating the resultant solvent/oil mix from the treated kernel to leave a nutritional composition substantially free of phorbol esters.

Preferably, the oil seed kernel is Jatropha curcas oil seed kernel.

As such, the methods of the invention simultaneously produce oil and a toxin free nutritional composition (seedcake) from the oil seed crop. Included within the oil are the products that are extracted with the solvent and these can include triglycerides, free fatty acids, saponins, phorbol esters, phytates, gums, lipids and other solvent soluble components.

The content of the seedcake can be analysed by methods known in the art. For example, the phorbol esters content could be analysed by HPLC.

A further aspect of the present invention relates to a nutritional composition produced from Jatropha curcas kernel, wherein the nutritional composition comprises less than about 100 ppm phorbol esters.

Preferably, the nutritional composition comprises less than about 50 ppm phorbol esters, preferably less than about 30 ppm phorbol esters, preferably less than about 20 ppm phorbol esters, preferably less than about 10 ppm phorbol esters. Preferably, the nutritional composition comprises undetectable levels of phorbol esters.

Preferably, the level of phorbol esters is determined by HPLC.

Preferably, the nutritional composition comprises at least about 50% by weight protein, preferably at least about 60% by weight protein, preferably at least about 64% by weight protein.

Preferably, the protein comprises at least about 60% by weight digestible protein, preferably at least about 65% by weight, preferably at least about 70% by weight, preferably at least about 80% by weight, preferably at least about 85% by weight, preferably at least about 90% by weight, preferably at least about 95% by weight, preferably at least about 97% by weight, preferably at least about 98% by weight.

Preferably, the nutritional composition does not contain shell material. Preferably, the nutritional composition comprises less than about 1% by weight shell material, preferably less than about 5% by weight, less than about 10% by weight, preferably less than about 20% by weight shell material.

Preferably, the nutritional composition comprises less than about 5% by weight oil, preferably less than about 4% by weight oil, preferably less than about 3% by weight oil, preferably less than about 2% by weight oil, preferably less than about 1% by weight oil, preferably less than about 0.5% by weight oil. Preferably, the nutritional composition comprises substantially no oil.

Preferably, the nutritional compositions of the present invention can be used in a variety of animal feeds, for example, chicken feed, ruminant feed, swine feed, fish feed, cat feed, dog feed or rodent feed.

In one aspect of the present invention, there is provided a method for extracting oil and at least one toxin from oil seed kernel, the method comprising: —

(a) treating the oil seed kernel with at least one solvent; and

(b) separating the resultant solvent/oil mix from the treated kernel to leave a seedcake substantially free of toxins.

Within this specification embodiments have been described in a way which enables a clear and concise specification to be written, but it is intended and will be appreciated that embodiments may be variously combined or separated without parting from the invention.

Example embodiments of the present invention will now be described with reference to the accompanying figures.

### BRIEF DESCRIPTION OF THE DRAWINGS

FIG. 1 shows a diagrammatic representation of a seed 1 comprising a seed kernel 2 and a seedcoat 3.

### DETAILED DESCRIPTION OF THE INVENTION

The invention relates to methods for extracting oil and phorbol esters from oil seed kernel. The methods provide for simultaneous removal of oil and elimination of toxins and antinutritional factors in oil seed bearing crops. The methods of the invention find particular application in relation to Jatropha curcas.

Also described are seedcakes and nutritional compositions produced by the methods of the invention. The seedcakes and nutritional compositions of the invention can be used as a variety of animal feeds, either alone or as part of a blend of other ingredients, depending upon the intended recipient.

The genetic origin of Jatropha curcas is believed to be Central America. However, the process described herein was developed with the grain of Jatropha curcas bought in Cape Verde from local suppliers.

The methods used in the invention and detailed examples of the invention are set out below.

Within this specification embodiments have been described in a way which enables a clear and concise specification to be written, but it is intended and will be appreciated that embodiments may be variously combined or separated without parting from the invention.

Within this specification, the terms “comprises” and “comprising” are interpreted to mean “includes, among other things”. These terms are not intended to be construed as “consists of only”.

Within this specification, the term “animal” includes, for example, domestic and non-domestic livestock. Specific examples include chickens, ruminants, pigs, fish including tropical fish, cats, dogs, rodents, and so on.

Within this specification, the term “substantially free of phorbol esters” means less than about 100 ppm phorbol esters, preferably less than about 50 ppm phorbol esters, preferably less than about 30 ppm phorbol esters, preferably less than about 20 ppm phorbol esters, preferably less than about 10 ppm phorbol esters, most preferably undetectable levels of phorbol esters. Phorbol esters can be detected using known methods, for example using HPLC methods known to those skilled in the art.

Within this specification, the term “about” means plus or minus 20%, more preferably plus or minus 10%, even more preferably plus or minus 5%, most preferably plus or minus 2%.

Within this specification, the term “seedcake” means the byproduct of extracting oil from seeds. Put another way, once the oil has been extracted, what is left is termed the “seedcake”. In relation to the present invention, the seedcake which results from extracting oil from the oil seed kernel is substantially free of phorbol esters. As such, the seedcake of the present invention can be used as an animal feed and may also be referred to as a seedmeal in the embodiments described herein.

Preferably, the seedcake comprises less than about 5% by weight oil. Preferably, the seedcake comprises less than about 4% by weight oil, preferably less than about 3% by weight, preferably less than about 2% by weight, preferably less than about 1% by weight. Preferably, the seedcake comprises less than about 0.5% by weight oil. Preferably, the seedcake comprises substantially no oil.

Within this specification, the term “seedmeal” means the byproduct of extracting oil from seeds, wherein said byproduct can be used as an animal feed.

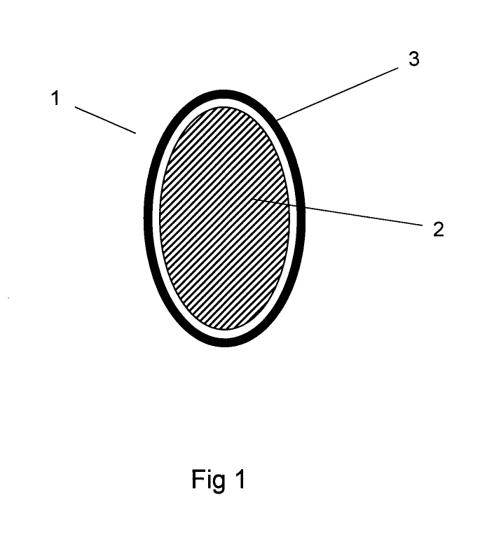

Within this specification, the term “shell material” means material which forms the shell around the seed, for example, a seed from Jatropha curcas. The shell of the seed (also referred to as the seedcoat or hull) corresponds to the casing which surrounds the seed kernel. This is shown in FIG. 1. It will be appreciated that the terms “shell material”, “shell”, “hull” and “seedcoat” do not relate to the fleshy material, known as the pericarp, which surrounds some seeds. For example, the fruit from a Jatropha tree comprises a fleshy outer pericarp within which are contained the seeds.

Within this specification, the term “seed kernel” means the material found inside a seed, for example, that which is incased by the seedcoat. The seed kernel comprises a seed embryo and an endosperm. In the example of a seed from Jatropha curcas, it is the seed kernel that contains the vast majority of the oil.

With reference to FIG. 1, a seed 1 comprises a seed kernel 2 and a seedcoat 3. In some examples, the seed 1 is surrounded by a fleshy pericarp (not shown).

Within this specification, the term “digestible protein” means “biologically digestible protein”. This term is well known in the art. One way of defining the term “digestible protein” is the protein which is easily digestible by an animal or the protein which can be metabolised by the animal (total protein fed minus the protein lost in faeces).

As food moves through the gastrointestinal tract, it is subject to a variety of physical and chemical processes. The net effect of the processing of the food is digestion, which is necessary to enable absorption.

Digestion is the process of splitting the large molecules of major nutrients (protein, fat, carbohydrates) into smaller components (amino acids, fatty acids, glucose). The enzymes in the gastrointestinal tract control the process of digestion.

Absorption is the passage of the digested nutrients through the intestinal membranes. The main organ of both digestion and absorption is the small intestine. (McDonald, P., Edwards, R. A. & Greenhalgh, J. F. D. (1994) Animal Nutrition, 4th edn (Harlow, Essex, England, Longman Scientific & Technical, the content of which is incorporated herein by reference in its entirety).

Measurements of digestion in vitro can be carried out by various methods known to the art. For example, The Protein Digestibility Index (PDI) method (Zhang, Y; Parsons, CM (1996) Poultry Science Volume: 75, 514-518, the content of which is incorporated herein by reference in its entirety). This method involves the following: Weigh approximately 1.5 g of sample in duplicate into 250 ml beakers, recording exact weights. Add 75 ml of 0.2% KOH, stir for 20 minutes; the samples should be stirred at the same rate (75% of maximum velocity) using a magnetic stir bar 3.6 cm in length. Pour approximately 50 ml of the mixture into plastic screw top tubes, centrifuge at 1750 rpm for 10 minutes. Pipette 15 ml of supernatant into kjeldahl tube. Determine nitrogen content of the supernatant by kjeldahl method. Weigh approximately 0.5-1.0 g of original sample onto ashless filter paper, place in kjeldahl tube and determine nitrogen content by the kjeldahl method. The nitrogen values obtained for the supernatant and original sample are multiplied by 6.25 to yield crude protein and the PDI is then calculated as a percentage of the total in the original sample.

$$P D I = \frac{( \% \text{nitrogen in supernatant} \times 6.25 ) \times 5}{\% \text{nitrogen in original sample} \times 6.25} \times 100$$

As described in further detail, the present invention relates to a process for producing a seedcake that is very high in digestible protein, free from toxins and anti-nutritional factors and simultaneously extracting high quality oil. Oil seeds are first cleaned, cracked and de-shelled and reduced in particle size before being treated with solvent to extract oil and certain toxins, followed by the denaturing of anti-nutritional factors by application of moist heat. As a result the seedcake is low in phorbol esters (PEs) and suitable for use as a feed.

The invention described herein shows that it is possible to reduce phorbol esters below about 10 ppm in the seedcake using a combination of particle size, temperature and solvents, and simultaneously produce oil.

Whereas others have attempted to reduce PEs in Jatropha using single solvents such as methanol or steam, this does not translate into an industrial biofuel process as oil remains in the meal. As described herein, we have been able to simultaneously extract oil and leave a high protein containing meal that is low in PEs and other ANFs. By utilising ethyl acetate and methanol in a ratio ranging from 30%-70% by weight ethyl acetate, nearly all the oil and all the PEs can be extracted from the kernels. After evaporating the miscella to desolventise the oil, the oil then contains the PEs. The PEs can subsequently be extracted and converted to high value pharmaceutical products or left in the oil for additional calorific value.

In one example, the process comprises dehulling the Jatropha kernel to above 90%. The kernel is then reduced in size by flaking or milling to give one dimension of less than 2 mm and is then mixed with solvent in an agitated batch vessel or continuous extractor in a number of stages. At each stage solvent containing less oil (and more fresh solvent) is mixed with the kernels to extract the PEs and the oil. The meal is desolventised using wet heat at 120° C. or above for less than 60 minutes to denature some of the ANFs to produce a meal that is high in protein and low in phorbol esters. The miscella is evaporated to allow the solvent to be reused and the oil to be sent to downstream refining or combustion units.

### EXAMPLES

We have tested hexane extraction (Example 1), methanol extraction (Example 2), ethyl acetate extraction (Example 3), the effect of particle size (examples 4 and 5), ethyl acetate extraction followed by methanol in a 2 stage process (example 6), ethyl acetate plus methanol extraction in a 1 stage process (Example 7), ethyl acetate followed by methanol in a large (1 kg) scale 2 stage process (Example 8), ethyl acetate plus methanol in a large (1 kg) scale 1 stage process (Example 9), and ethyl acetate plus methanol in a 1 stage 50 gm batch extraction (Example 10), ethyl acetate plus methanol in a 1 stage 35 kg batch extraction. (example 11). Oil has been recovered from each process and quantified, and PEs have been extracted and analysed by HPLC.

TABLE 1
A summary of the results obtained in Examples 1 to 11 (as discussed below)

| | | Average oil | Oil in | | |
|---|---|---|---|---|---|
| | | yield in | meal | | |
| | | miscella (% | (% wt | PE (ppm | |
| ID | Treatment | wt kernel) | kernel) | kernel) | Comments |
| 1 | Hexane extracted kernel | 50-57 | <5 | 200-300 | 4 hr soxhlet |
| 2 | Methanol extracted kernel | 37 | 17 | 0 | 2 hr by soxhlet |
| 3 | ethyl acetate extracted kernel | 54 | <2 | 268 | 2 hr by soxhlet |
| 4 | Effect of particle size-coarse | 21 | n/a | 80 | 4 hr by soxhlet |
| 5 | Effect of particle size-fine | 52 | n/a | 0 | 4 hr by soxhlet |
| 6 | ethyl acetate followed by | 54 | <2 | 300 | 1 hr each by soxhlet |
| | Methanol extraction of kernel - | | | | |
| | 2 stage process | | | | |
| 7 | ethyl acetate + Methanol | 49 | <5 | 4 | 1 hr by soxhlet |
| | extraction of kernel - 1 stage | | | | |
| | process | | | | |
| 8 | ethyl acetate + methanol - 2 | 55 | 4.7 | 0 | Multistage Batch |
| | stage process - 1 kg scale | | | | extractor |
| 9 | ethyl acetate + methanol - 1 | 51 | 2.3 | 4 | Multistage Batch |
| | stage process - 1 kg scale | | | | extractor |
| 10 | ethyl acetate + methanol - 1 | 53 | <2 | 21 | Batch extractor |
| | stage process - 50 gm batch | | | | |
| | scale | | | | |
| 11 | Ethyl acetate + Methanol - 1 | >50 | <0.5 | undetectable | Industrial batch |
| | stage process - 35 Kg industrial | | | | extractor |
| | batch scale | | | | |

### Example 1

### The Use of Hexane Alone (i.e. without Expelling of Oil) was Investigated

A small scale continuous extraction (4 hr) with a solvent/mass ratio of 500/1 was carried out at the boiling point of the solvent and oil was recovered from the solvent by evaporation of hexane under vacuum. The defatted meal was extracted with methanol for 1 hour and PEs were analysed after evaporation of solvent, by HPLC. Hexane was effective at removing almost all oil from the kernel (50-57% of kernel weight), yielding a meal with an oil content of less than 5% by weight, but was not effective at removing all PEs from the meal. Residual PE was 200-300 ppm kernel.

### Example 2

### The Use of Methanol Alone to Extract Oil and PEs from Kernel was Investigated

A small scale continuous extraction (2 hr) with a solvent/mass ratio of 200/1 was carried out at the boiling point of the solvent and oil was recovered from the solvent by evaporation of methanol under vacuum. The resulting meal was re-extracted with methanol for 1 hour and PEs were analysed after evaporation of solvent, by HPLC. Methanol removed only 37% kernel weight of oil from the kernel, yielding a meal with an oil content of more than 17% by weight, but was effective at removing all PEs from the meal. No PEs were detectable in the resulting meal.

### Example 3

### The Use of Ethyl Acetate Alone to Extract Oil and PEs from Kernel was Investigated

A small scale continuous extraction (2 hr) with a solvent/mass ratio of 200/1 was carried out at the boiling point of the solvent and oil was recovered from the solvent by evaporation of ethyl acetate under vacuum. The resulting meal was re-extracted with methanol for 1 hour and PEs were analysed after evaporation of solvent, by HPLC. Ethyl acetate removed almost all oil (54% kernel weight) from the kernel, yielding a meal with an oil content of less than 2% by weight, but was not effective at removing all PEs from the meal. The resulting meal contained 268 ppm PE of kernel.

### Examples 4 and 5

### To Determine the Effect of Particle Size on Extraction of Oil and PEs from Kernel

A small scale continuous extraction was carried out for 4 hours to determine the effect of particle size on extraction of oil and PEs by methanol. Fine material was milled and sieved through a 1 mm mesh whereas coarse material was only milled and extracted as particles of size greater than 1 mm; the solvent/mass ratio was 500/1. After extraction, oil was recovered from solvent by evaporation and the meal was re-extracted with methanol to determine residual levels of PE. For fine material, oil recovery was 52% of kernel weight and there was no detectable PE remaining in the meal. For coarse material, oil recovery was 21% of kernel weight and residual PEs were 80 ppm of kernel weight.

### Example 6

### To Examine the Effectiveness of a 2 Stage Continuous Extraction with Ethyl Acetate Followed by Methanol on the Recovery of Oil and Removal of PE from Fine Milled Kernel

In a small scale continuous extraction, fine milled kernel was extracted for 1 hour with ethyl acetate, followed by 1 hour with methanol. Oil was recovered from solvent by evaporation, and the residual meal was extracted with methanol for 1 hour to measure residual PE by HPLC. Oil recovery was maximal at 54% kernel weight, and residual oil in the meal was less than 2%. Residual PE levels in the meal was high, at 300 ppm kernel.

### Example 7

### To Examine the Effectiveness of a 1 Stage Continuous Extraction with Ethyl Acetate Plus Methanol on the Recovery of Oil and Removal of PE from Fine Milled Kernel

In a small scale continuous extraction, fine milled kernel was extracted for 1 hour with a 50/50 mixture of ethyl acetate and methanol, at a solvent/mass ratio of about 100. Oil was recovered from solvent by evaporation, and the residual meal was extracted with methanol for 1 hour to measure residual PE by HPLC. Oil recovery was high at 49% kernel weight, and residual oil in the meal was less than 5% by weight. Residual PE levels in the meal was low, at 4 ppm kernel.

### Example 8

### To Determine Effectiveness of Large Scale Batch Extraction on Oil Recovery and Residual PE Levels in the Meal, Using a 2 Stage Extraction with Ethyl Acetate Followed by Methanol

A batch extraction process was tested in which 1 kg of fine milled kernel was extracted with 8 litres of ethyl acetate followed by 8 litres of methanol at 60° C. and a flow rate of 6 litres/min. 5 cycles of 1 hour each were carried out. Oil was recovered by solvent evaporation, and a sample of meal was continuously extracted for 1 hour with methanol to determine residual PE levels in the meal. Desolventising was at 160° C. for 20 min in a stirred heating chamber. The meal was autoclaved with 120° C. moist heat for 60 mins to remove ANFs before use in animal trials. Oil yield was 55% of kernel weight and meal contained less than 5% by weight oil. There was no detectable residual PE in the meal.

### Example 9

### To Determine Effectiveness of Large Scale Batch Extraction on Oil Recovery and Residual PE Levels in the Meal, Using a 1 Stage Extraction with Ethyl Acetate Plus Methanol

A batch extraction process was tested in which 1 kg of fine milled kernel was extracted with 8 litres of a 50/50 mixture of ethyl acetate and methanol at 60° C. and a flow rate of 6 litres/min; 5 cycles of 1 hour each were carried out. Desolventising was at 160° C. for 20 min in a stirred heating chamber. The meal was autoclaved with 120° C. moist heat for 60 mins to remove ANFs before use in animal trials. Oil was recovered by solvent evaporation, and a sample of meal was continuously extracted for 1 hour with methanol to determine residual PE levels in the meal. Oil yield was 51% of kernel weight and meal contained less than 5% by weight oil. Residual PE in the meal was 4 ppm kernel.

### Example 10

### The Use of Mixed Solvents in Intermediate Scale Continuous Extraction to Recover Oil and Remove PEs from Fine Milled Kernel

Continuous extraction of 50 gm of fine milled kernel was tested using a mixed solvent preparation of ethyl acetate and methanol at their azeotrope, with a mass/solvent ratio of 10/1. Oil was recovered by solvent evaporation and residual PE was determined by 1 hour methanol extraction of a sample of the meal and HPLC. Oil yield was 53% by weight of kernel and residual PE was 10.5 ppm kernel.

### Example 11

### To Determine Effectiveness of Industrial Scale Batch Extraction on Oil Recovery and Residual PE Levels in the Meal, Using a 1 Stage Extraction with Ethyl Acetate Plus Methanol

A batch extraction process was tested in which 35 kg of flaked kernel was extracted with 350 Kg of a 40/60 mixture of ethyl acetate and methanol at 62° C. and 1.2 bar absolute, and a mixing rate of 10 revs/min; 6 cycles of 1 hour each were carried out. Desolventising was at 100° C. for 80 min in a vertical steam desolventiser. The meal was autoclaved with 120° C. moist heat for 60 mins to remove ANFs before use in animal trials. Oil was recovered by solvent evaporation, and a sample of meal was continuously extracted for 1 hour with methanol to determine residual PE levels in the meal. Oil yield was >50% of kernel weight and meal contained less than 0.5% oil by weight. Residual PE in the meal was undetectable.

### Bioassays

As well as HPLC measurements, bioassays using brine shrimps and Drosophila larvae were used to confirm the detoxification potential of the treated meal. It was found that 10% inclusion of raw defatted Jatropha meal resulted in 100% mortality. However, when subjects were fed with a meal containing the processed meal produced by the methods described above, growth above control was observed, suggesting good feed potential of the seedcake.

### Proximate and ANF Analysis

Meal produced by the batch extraction process was analysed to determine its potential nutritive value and ANF level.

summary of antinutritional analysis, PE, proximate and amino acid
analysis

| | units | value | comments |
|---|---|---|---|
| Analysis | | | |
| soluble protein | mg/gm DM | 306.1 | total protein, |
| | | | 61% |
| haemaglutination | 1/mg/ml | 0 | |
| trypsin inhibitors | IC50, ug kernel/uni | 0 | |
| phytate | % | 1.11 | |
| Curcin | control/sample | 2.61 | Soy control, |
| | | | 1.9. raw, |
| | | | >10,000 |
| saponins | % DW | <0.4 | |
| phorbol esters | ug/gm meal | not | <10 ppm |
| | | detected | |
| brineshrimp toxicity | % mortality at 20 hr | 5 | |
| (20 mg/ml) | | | |
| Drosophila toxicity | % mortality | 0 | |
| Proximate | | | |
| Dry matter | g/kg | 919.6 | |
| crude protein | g/kg DM | 609 | |
| ash | g/kg DM | 129 | |
| crude fibre | g/kg DM | 107 | |
| acid hydrolysed | g/kg DM | 4.05 | |
| ether extract | | | |
| NCGD (N) | % DM | 84.2 | |
| total sugars | g/kg DM | 1.84 | |
| starch | g/kg DM | 16.5 | |
| Metabolisable Energy - | Mj/kg DM | 11.9 | |
| wet chemistry | | | |

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications are covered by the appended claims.

1-46. (canceled)

47. A method for extracting oil and phorbol esters from oil seed kernel, the method comprising: —
(a) treating an oil seed kernel with at least one solvent; and
(b) separating the resultant solvent/oil mix from the treated kernel to leave a seedcake substantially free of phorbol esters, wherein phorbol esters are removed from the oil seed kernel at the same time as extracting oil.

48. A method according to claim 47, wherein the oil seed kernel is Jatropha curcas oil seed kernel, and/or wherein the solvent comprises a mixture of two or more solvents, and/or wherein the solvent comprises at least one hydrophobic solvent, and/or wherein the solvent comprises at least one hydrophilic solvent.

49. A method according to claim 47, wherein the solvent comprises two or more solvents and wherein one of the solvents is more hydrophilic than another of the two or more solvents, and/or wherein the solvent comprises between about 30% and about 70% hydrophobic solvent, and/or wherein the solvent comprises about 55% hydrophobic solvent, and/or wherein the solvent comprises an azeotropic mix of a hydrophobic and a hydrophilic solvent, and/or wherein the solvent comprises an alkane, an ester, an alcohol or a heterocyclic organic compound, or a combination of two or more thereof, and/or wherein the solvent comprises less than about 6 carbon atoms.

50. A method according to claim 47, wherein the solvent comprises an alkanol or an ester of methane, ethane, propane or butane, or a combination of two or more thereof, and/or wherein the solvent comprises hexane, methyl acetate, ethyl acetate, methanol, ethanol or tetrahydrofuran or a combination of two or more thereof.

51. A method according to claim 47, wherein the solvent comprises a mixture of ethyl acetate and methanol.

52. A method according to claim 47, wherein the solvent comprises between about 30% by weight and about 70% by weight ethyl acetate or methyl acetate, and/or wherein the solvent comprises about 55% ethyl acetate or methyl acetate or an azeotropic mixture of ethyl acetate and methanol, an azeotropic mixture of ethyl acetate and ethanol, an azeotropic mixture of methyl acetate and methanol, or an azeotropic mixture of methyl acetate and ethanol.

53. A method according to claim 47, wherein step (a) comprises treating the oil seed kernel with a first solvent followed by a second solvent.

54. A method according to claim 53, wherein the first solvent and/or the second solvent comprises a mixture of two or more solvents, and/or wherein the first solvent and/or the second solvent comprises at least one hydrophobic solvent, and/or wherein the first solvent and/or the second solvent comprises at least one hydrophilic solvent, and/or wherein the first solvent and/or the second solvent comprises two more solvents and wherein one of the solvents is more hydrophilic than another of the two or more solvents, and/or wherein the first solvent and/or the second solvent comprises between about 30% by weight and about 70% by weight hydrophobic solvent, and/or wherein the first solvent and/or the second solvent comprises about 55% by weight hydrophobic solvent, and/or wherein the first solvent and/or the second solvent comprises an azeotropic mix of a hydrophobic and a hydrophilic solvent, and/or wherein the first solvent and/or the second solvent comprises an alkane, an ester, an alcohol or a heterocyclic organic compound, or a combination of two or more thereof and/or wherein the first solvent and/or the second solvent comprises less than about 6 carbon atoms, and/or wherein the first solvent and/or the second solvent comprises an alkanol or an ester of methane, ethane, propane or butane, or a combination of two or more thereof, and/or wherein the first solvent and/or the second solvent comprises hexane, methyl acetate, ethyl acetate, methanol, ethanol or tetrahydrofuran, or a combination of two or more thereof, and/or wherein the first solvent and/or the second solvent comprises a mixture of ethyl acetate and methanol, and/or wherein the first solvent and/or the second solvent comprises between about 30% by weight and about 70% by weight ethyl acetate or methyl acetate, and/or wherein the first solvent and/or the second solvent comprises about 55% by weight ethyl acetate or methyl acetate or an azeotropic mixture of ethyl acetate and methanol, an azeotropic mixture of ethyl acetate and ethanol, an azeotropic mixture of methyl acetate and methanol, or an azeotropic mixture of methyl acetate and ethanol.

55. A method according to claim 47, wherein prior to treatment with a solvent the kernel is reduced to a particle size of less than about 2 mm in one dimension, and/or wherein oil is not pre-expelled from the seed kernel prior to treatment with solvent, and/or wherein the seed kernel is not subjected to heat treatment prior to treatment with solvent and/or wherein the oil seed kernel comprises at least about 80% by weight oil seed kernel, and/or wherein at least about 80% by weight of the oil in the oil seed kernel is extracted, and/or wherein at least about 40% oil by weight of kernel is extracted, and/or wherein the seedcake comprises at least about 50% by weight protein, and/or wherein the protein comprises at least about 60% by weight digestible protein.

56. A method according to claim 47, wherein the seedcake comprises less than about 100 ppm phorbol esters.

57. A method according to claim 47, wherein the method comprises a further step (c), comprising treating the seedcake to remove or denature antinutritional factors, optionally wherein step (c) comprises treating the seedcake to remove or denature antinutritional factors selected from one or more of cursin, trypsin inhibitors, lectins, phytates or saponins.

58. A seedcake produced by a method according to claim 47.

59. A nutritional composition comprising a seedcake according to claim 58.

60. An animal feed comprising a seedcake according to claim 58.

61. An animal feed according to claim 60, wherein the animal feed is selected from domestic and non-domestic animal feed, optionally chicken feed, ruminant feed, swine feed, fish feed, cat feed, dog feed or rodent feed.
